(19) United States
(12) Patent Application Publication
(10) Pub. No.: US 2002/0129546 A1
(43) Pub. Date: Sep. 19, 2002

(54) Dividing element for a landscape divider and landscape divider with at least one such dividing element

(76) Inventor: Georg Baumann, Furstenzell-Jagerwirth (DE)

Correspondence Address: HOFFMAN WASSON & GITLER, 2361 JEFFERSON DAVIS HIGHWAY, SUITE 522, ARLINGTON, VA, 22202

(21) Appl. No.: 10/042,288

(22) Filed: Jan. 11, 2002

(30) Foreign Application Priority Data
Jan. 13, 2001 (DE) 101 01 322.1-23
Jan. 3, 2002 (EP) 02000018.8

(51) Int. Cl. A01G 1/00

(52) U.S. Cl. 47/33

(57) ABSTRACT

The present invention relates to a landscape divider including at least one dividing element, which is fabricated of a sheet-like material and has at least one bent edge forming a U-shaped cross-section.

### BACKGROUND OF THE INVENTION

The present invention relates to a dividing element for landscape divider.

A landscape dividing system is known in the art (WO99/07204) that essentially comprises consecutive, interlocking strip-shaped panels that can be fastened by means of ground anchors so that they stand upright on an underlying surface. The panels are profiled to form a U-shaped edge on the top and bottom longitudinal edges of one side of the panel in addition to several strip-like projections and recessions extending in the longitudinal direction of the panel. In the vicinity of the longitudinal edges, strip-like projections are molded onto the other side of the panels. These make it possible to interlock each panel into the undercuts of a connected panel formed by the U-shaped edges.

The panels are manufactured of a material, for example aluminum or plastic, which makes the production of such a profile by extrusion possible. The panels or dividing elements of this known system are not suitable for insertion into the underlying surface or ground by means of driving without first opening or digging this underlying surface.

A further landscape divider is known (U.S. Pat. No. 4,281,473) that has at least one panel-like dividing element, which is provided with a tube-like cross-section on its upper edge extending in the longitudinal direction of the dividing element and connecting to this with a corrugated panel section, the corrugations of which extend perpendicular to the upper edge. A flat or essentially flat panel section is connected to this corrugated section toward the lower edge of the dividing element. At the intersection of the corrugated and the flat panel section, barbed wing-like protruding wall sections are molded onto the surface extending in the longitudinal direction of the dividing element. This known dividing element has a very complex design and is therefore expensive to manufacture.

A further ring-shaped dividing element is known (U.S. Pat. No. 5,465,526), which is curved from a flat material to form the ring and has an upper U-shaped bent edge. This known landscape divider does not possess a profile.

Further landscape divider elements are known in the form of flat, non-profiled panels or sheets (GB 1 476 723), which only have bent or U-shaped bent edge sections.

The object of the present invention is to provide a dividing element which makes it particularly easy to achieve a landscape divider in such a way that the landscape divider produced is stable and capable of bearing a load, so that even driving over the landscape divider with heavy lawn mowers is possible without damaging the landscape divider and without the danger of the divider sinking into the underlying surface.

### SUMMARY OF THE INVENTION

The special feature of the dividing element according to the present invention, is that it is manufactured of no-rust steel, preferably of chromium steel, by profiling, in particular, in a preferred embodiment of the present invention, with the upper edge which forms a U-shaped profile by bending the steel sheet and with the corrugation extending parallel to this upper edge.

The material used is hard enough that despite the corrugation extending crosswise to the direction of insertion, it is possible to insert the respective dividing element into the ground by means of hammering without digging. The corrugation extending parallel to the upper edge and therefore crosswise to the insertion direction causes compression of the ground during insertion. This achieves more reliable anchoring and, in particular, also prevents unwanted sinking of the landscape divider when placed under load, for example when driven over by heavy lawn mowers, etc.

Due to the upper U-shaped bent edge, the dividing element provides a high degree of stability in addition to an attractive appearance after being inserted into the ground and also prevents the danger of injury from sharp edges.

The landscape divider according to the present invention, which in the simplest case is a single dividing element, which can be manufactured in a wide variety of shapes, such as round, square, oval, etc.

In one possible embodiment of the present invention, the landscape divider is made of several consecutive dividing elements, so that the length and course of the landscape divider can be adjusted ideally by using a corresponding number of dividing elements according to the local circumstances or requirements. The consecutive dividing elements that make up the landscape divider are preferably connected to each other by means of connecting elements. Such connecting elements can be screws, plug-type connectors, clamp-type connectors, etc.

In a further possible embodiment of the present invention, the landscape divider has a ring-shaped design and includes at least one dividing element that is curved into an open ring, for example and which can be connected to the closed ring by a connector, for example.

In a further possible embodiment of the present invention the panel made of corrosion-resistant steel forming the dividing element has anchors, the longitudinal side of which extend crosswise or perpendicular to the panel plane in the underlying surface, thus preventing the dividing element or the landscape divider from sinking.

In a further possible embodiment of the present invention the dividing elements or their panels that form the landscape divider are each provided with a U-bend on their narrow or cross side and are connected with each other in the area of these U-bends by means of fork-like connecting elements.

The landscape dividing system according to the present invention serves primarily to divide the edge of a lawn from a neighboring area. Along this edge it is possible to conveniently cut the lawn, in particular also with a lawn mower. The landscape divider according to the present invention also serves to protect against root damage, e.g. by moles and/or to prevent fertilizer from being washed away, thus resulting in increased yields from useful plants, for example, with a reduced need for fertilizer and a lower impact on the environment.

### BRIEF DESCRIPTION OF THE DRAWINGS

The present invention will be described in more detail below in conjunction with the drawings of representative embodiments.

FIG. 1 shows a simplified cross-section view of a landscape divider in accordance with the present invention;

FIG. 2 shows the dividing element in side view;

FIG. 3 shows a top view of two consecutive straight dividing elements of FIGS. 1 and 2;

FIG. 4-6 show a further possible embodiment of a dividing element in accordance with the present invention, similar to FIGS. 1-3;

FIG. 7 shows a top view of a dividing element designed as a ring in accordance with the present invention;

FIG. 8 and 9 show a side view and a top view of a further embodiment of the landscape divider in accordance with the present invention;

FIG. 10 and 11 show a simplified side view of two dividing elements before and after being connected;

FIG. 12 shows a simplified cross-section of the connection between the dividing elements of FIGS. 10 and 11;

FIG. 13 shows a simplified perspective view of a dividing element in a further possible embodiment of the present invention;

FIG. 14 shows a simplified partial view of the dividing element of FIG. 13 in a curved landscape divider;

FIG. 15 and 16 show different side views of an insertion element for manually inserting a dividing element in accordance with the present invention;

FIG. 17 shows a view similar to FIG. 15, however with mechanical insertion of a dividing element;

FIG. 18 shows a view similar to FIG. 15 of a further embodiment of the insertion element;

FIG. 19 shows various insertion elements in a curved dividing element;

FIG. 20 shows a simplified view of a receptacle;

FIG. 21 shows a simplified cross-section view of two consecutive dividing elements in accordance with the present invention;

FIG. 22 shows a simplified cross-section view of the dividing area in the connecting area corresponding to intersection line 1-1 of FIG. 21; and

FIG. 23 shows a top view of the consecutive dividing elements.

### DETAILED DESCRIPTION OF THE INVENTION

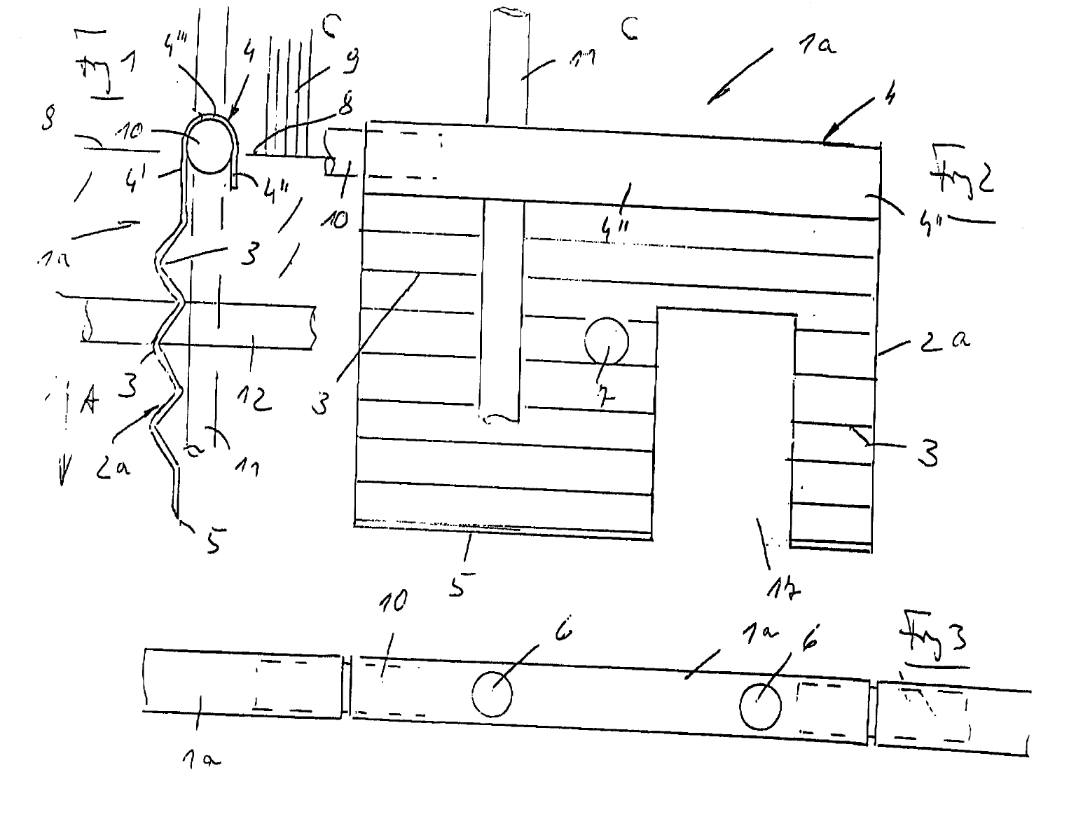

The dividing element generally designated la in FIGS. 1-3 is essentially designed as a rectangular panel 2 made of a suitable material, for example of a hard plastic, however preferably of a corrosion-resistant metal (e.g. steel), for example of chromium steel, whereby the panel 2a is profiled or corrugated and the corrugations 3 forming this profiling extend parallel to the longer sides (longitudinal sides) of the panel 2a. On one longitudinal side, which in the installed dividing element la also forms the top of this dividing element, the panel 2 has a bent longitudinal edge 4, so that the panel forms a U-shaped cross-section there, which is open toward the lower longitudinal side 5 of the panel 2a in the drawings and has leg sections 4′ and 4′″ and a yoke section 4′″ connecting these leg sections on the top of the panel 2a.

There are openings 6 in the yoke section 4″ at predefined distances. Further openings 7 are provided in the panel 2 outside of the bent longitudinal edge 4.

When installed, the respective dividing element 1a is inserted into the ground 8, for example pressed in or hammered in, in particular at the location where a divider, for example a landscape divider is desired, so that the lawn generally indicated with 9 in FIG. 1 located to the right, i.e. directly adjacent to the free leg 4″ cannot grow into the area located to the left of the dividing element 1a.

To form the landscape divider, the dividing elements 1a are inserted into the ground 8 one next to the other and connected with each other in the area of the bent longitudinal edges 4 by means of connecting elements 10. In the depicted embodiment, the connection elements 10 are pegs, which are held on one end by pinching and/or additional welding in the U-shaped cross-section formed by the bent longitudinal edge 4 and project with the other end beyond the narrow side of the dividing element 1a, so that the projecting end of the respective peg-like connecting element 10 can then be received by the U-shaped cross-section of the bent longitudinal edge 4 of the adjacent dividing element, thus forming a connection between the adjacent dividing elements 1a.

Rods or posts 11 can be pressed into the ground through the openings 6, e.g. rods or posts for a fence. The additional openings 7 on each panel 2a outside of the bent longitudinal edge 4 serve to receive rod-shaped ground anchors 12, which are located with their longitudinal side crosswise to the respective panel 2, thus securely anchoring the respective dividing element 1a in the ground and in particular also preventing the respective dividing element 1a from sinking when placed under load (e.g. when being driven over by a heavy lawn mower).

As shown in FIG. 1, the dividing elements 1a are inserted into the ground 8 in such a way that the profile or the corrugations 3 are located perpendicular to the direction of insertion (arrow A of FIG. 1) with their longitudinal side and that after being inserted essentially only the bent longitudinal edges 4 of these dividing elements project above the top of the ground and are visible. Due to the bent longitudinal sides the dividing elements 1a are highly stable and secure, so that especially mowing the lawn 9 with a lawn mower will not destroy the divider. The bent longitudinal edges 4 of the dividing elements 1a also give the divider an attractive appearance, in addition to preventing sharp edges that could cause injury.

The profile or corrugation 3 of the panel 2 parallel to its longitudinal edges also has the advantage, for example, that after being inserted into the ground 8, this profile provides additional anchoring of the respective dividing element 1a, in particular also preventing the divider from sinking into the ground 8 when driven over by a heavy machine, for example by a lawn mower.

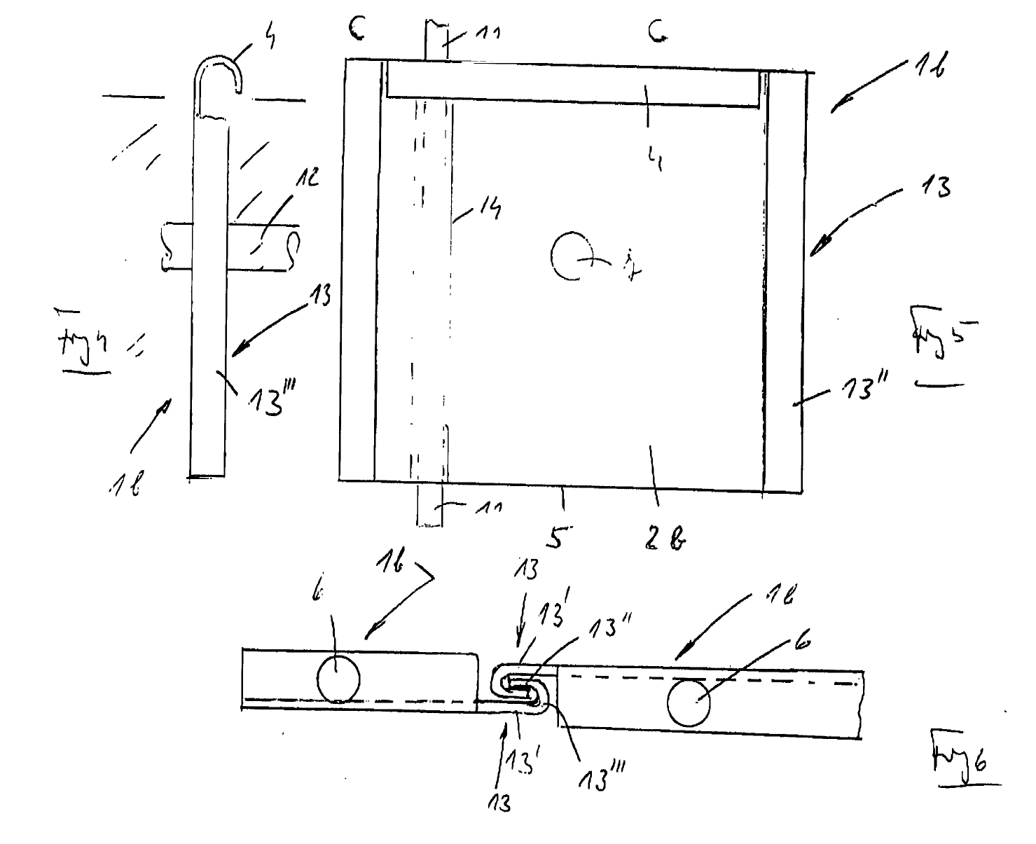

For the routing of connections for drainage systems in the ground 8, at least some of the dividing elements 1a or 1b used for the divider are provided with a recess toward the bottom edge of the panel, as indicated by 17 in FIG. 2.

As also shown in FIG. 1, the bent edge 4 is designed in such a way that this edge 4 is located completely to the side of the remaining profiled panel 2a, so that the rods 11 can be positioned through the openings 6 on the side of the profiled panel 2a facing the bent edge 4 and inserted into the ground.

As already mentioned above, the dividing elements are driven into the ground without digging. In addition, the profile or corrugation 3 extending perpendicular or crosswise to the direction of insertion (arrow 1) also results in compression of the ground in the vicinity of the respective dividing element 1a, so that it is then anchored especially securely in the ground.

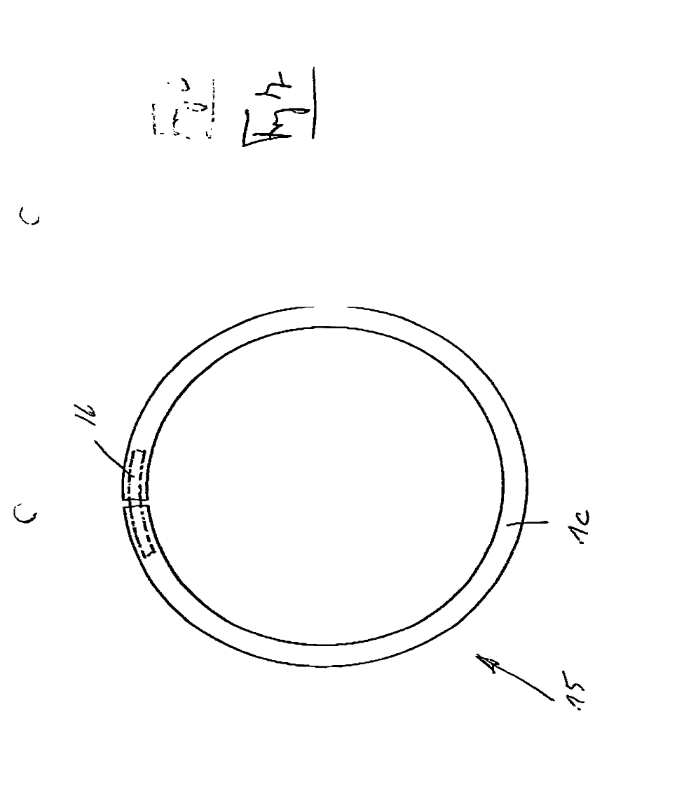

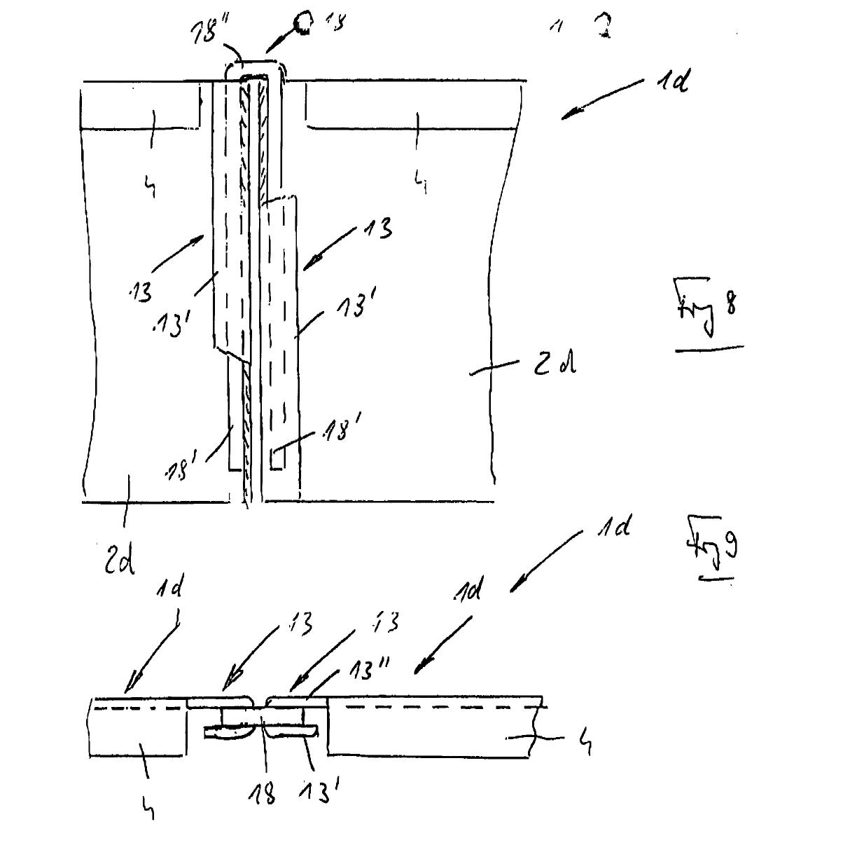

FIGS. 4-6 show a further possible embodiment of a dividing element 1b, which is formed by a non-profiled, i.e. a flat or essentially flat rectangular panel 2b, which when installed is provided with the bent longitudinal edge 4 on its upper longitudinal side and on the narrow sides with the bent edge 13, whereby the bent edge 4, in deviation from the dividing element 1a, does not extend along the entire length of the panel 2b. The bent edges 13, which are formed by the legs 13′ and 13″ and the yoke section 13′″ connecting the legs, serve in this embodiment to connect the consecutive dividing elements 1b. In the bent edge 4 there are openings 6, e.g. for the rods 11 and in the panel 2b there are openings 7 for the anchor 12. In addition, pipe sections 14 can be welded onto the panel 2b for the rods 11.

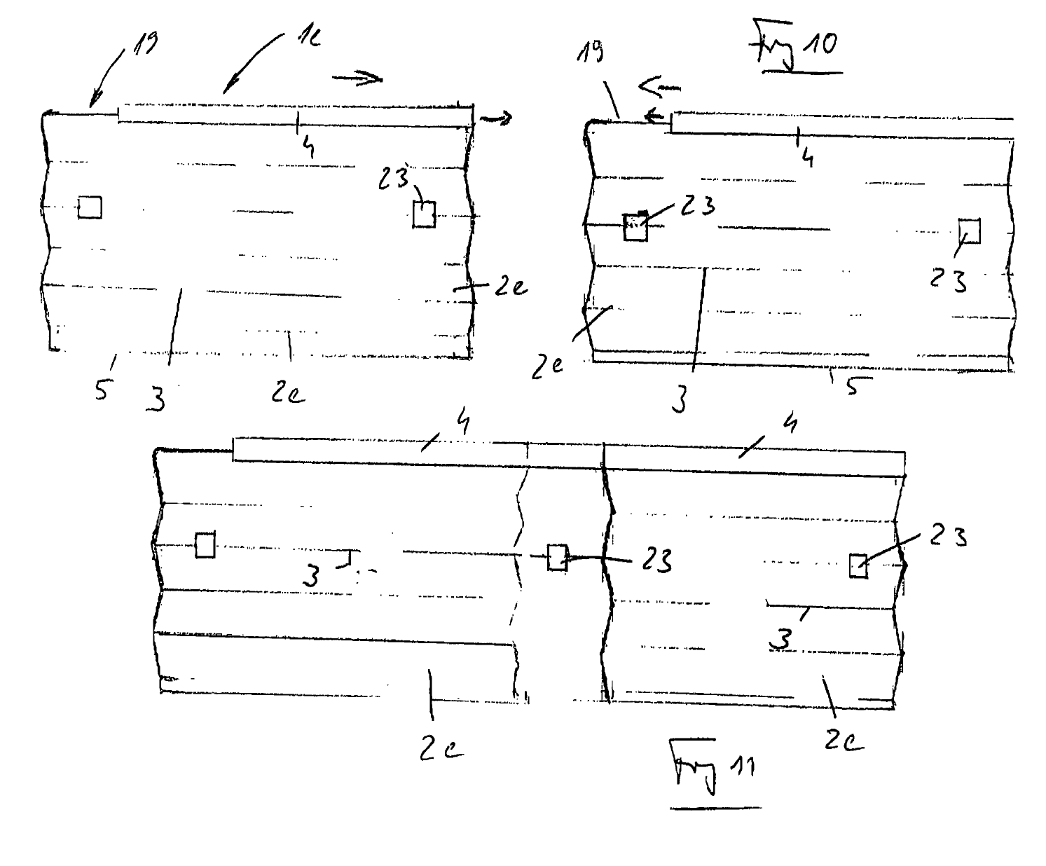

FIG. 7 shows a very simplified view of a ring-shaped landscaping divider 15. This divider includes a single ring-shaped curved dividing element 1c, as described above, for example in conjunction with FIGS. 1-6, and which has the shape of an open ring. The dividing element 1c is suitable, for example, as a landscaping divider around a tree or bush, etc. Due to the design as an open ring, the dividing element 1c can be placed around the trunk of a tree before being inserted into the ground 8 and then closed by means of a connecting element, for example by a curved connecting element 16 corresponding to the connecting element 10.

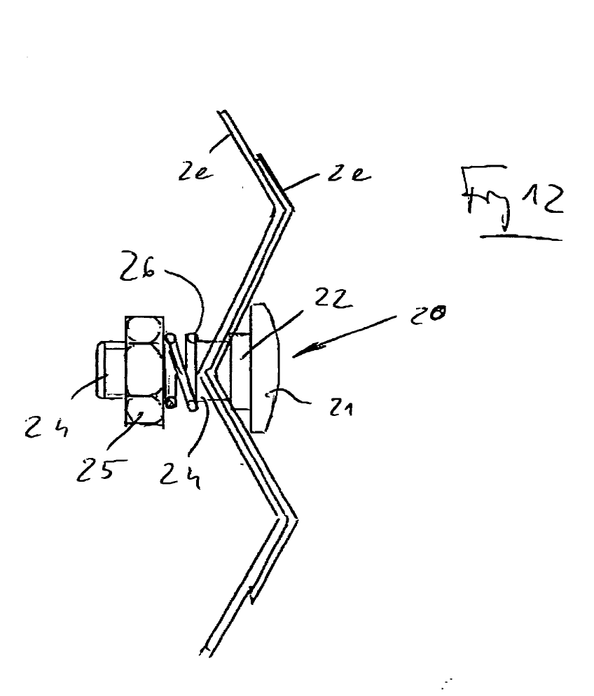

FIGS. 8 and 9 show as a further possible embodiment a modification of the landscaping divider of FIG. 4-6. This landscaping divider differs from the embodiment of FIGS. 4-6 by that fact that the individual consecutive dividing elements 1d that form the landscaping divider are inserted into the underlying surface or ground 8 in the same direction and the consecutive dividing elements 1d then connected by fork-like connecting elements 18, the legs 18′ or fork ends of which are received in a bent edge 13 of a panel 2d and of which the yoke section 18″ connecting the legs 18′ bears on the upper edge of the consecutive dividing elements 1d. The embodiment of FIGS. 8 and 9 has the advantage over the embodiment of FIGS. 4-6 of an especially attractive appearance. In addition, the areas of the upper edges of the dividing elements 1d that do not have a bent edge 4 are covered by the connecting elements 18 of their yoke section 18″.

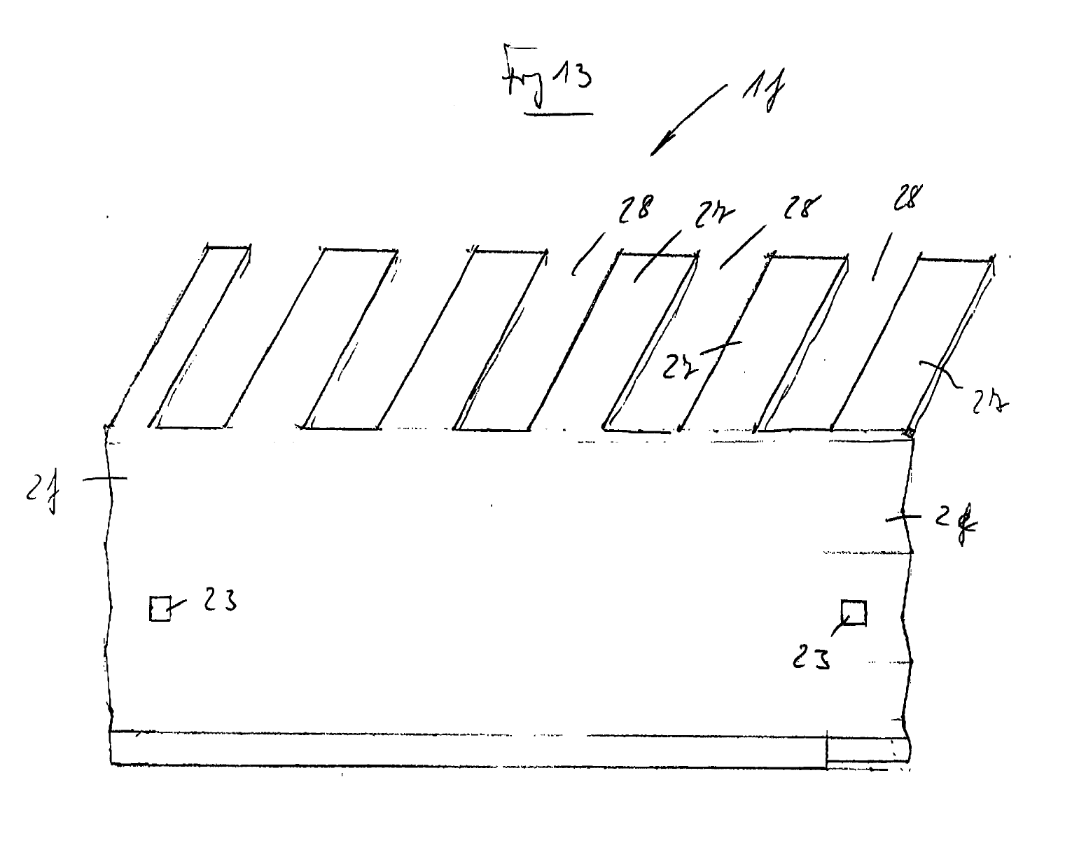

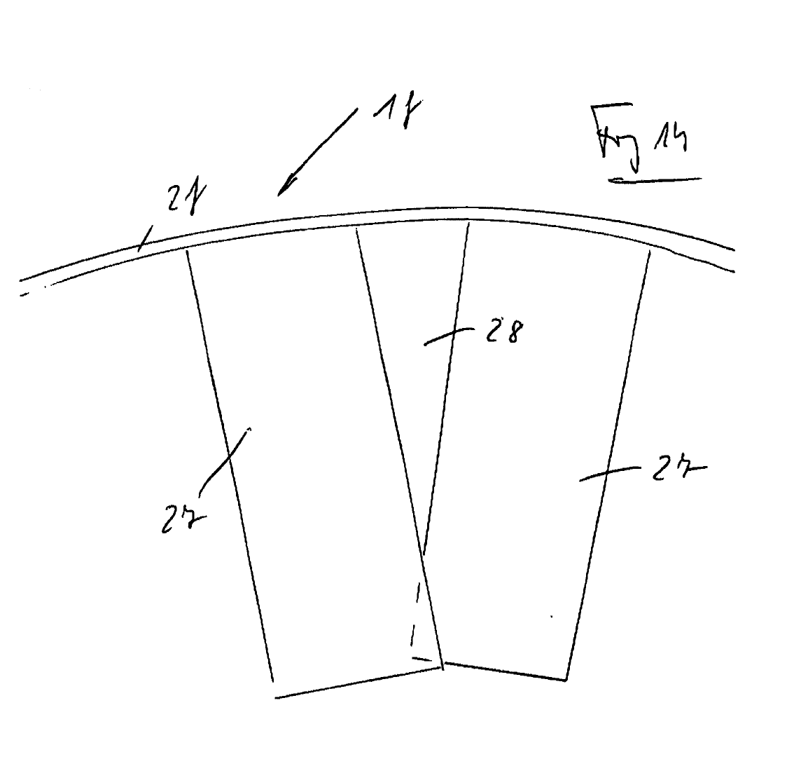

FIGS. 10 and 11 show a side view of two dividing elements 1e, which correspond to the dividing element 1a, but which differ from the dividing element 1a by the fact that the bent edge 4 in the dividing element 1e is notched on one side of this dividing element or the panel 2e along a predefined length, as designated by 19 in FIGS. 10 and 11. This notch 19 makes it possible to connect the two dividing elements or their panels 2a with overlapping interlocking profiles or corrugations 3, whereby the bent edges 4 of the consecutive panels form a nearly uniform border for the dividing elements 1e inserted into the ground. The slight overlapping of consecutive edges 4 in the area of the notch 19 is also in top view not visible or practically not visible, in particular due to the relatively low wall thickness of the panels 2e, which are likewise made of stainless steel, e.g. chromium steel.

FIG. 12 shows a connection between two dividing elements 1e or the panels 2e. The connection consists essentially of a screw 20, which screws with a four-edged section 22 connecting to the head 21 tightly into an adapted hole 23 in the respective panel 2e. With the threaded shank 24 connecting to the section 22, the screw 20 extends through the opening 23 of the dividing element 1e to be connected. On the screw shank 24 there is a nut 25, on which a pressure spring 26 surrounding the screw shank 24 is supported with one end and which bears with its other end against the side of the panel 2e to be connected facing the nut 25, so that the panels 2e to be connected are clamped between the screw head 21 and the spring 26 and pressed against each other in such a way that the panels 2e interlock with their corrugations 3 as soon as the consecutive panels 2e are aligned. The connection shown in FIG. 12 makes it possible, while pressing the spring 26, to swivel a panel 2e in relation to the connecting panel 2e on the axis of the screw 20, i.e. on an axis that is perpendicular to the plane of the panels 2e. This makes it possible to connect the dividing elements 1e or their panels before inserting them into the ground in the described manner and then to drive them into the ground one after the other, whereby, if two panels 2e are aligned while being inserted into the ground, the corrugations or profiles of these panels interlock. It is generally possible to dispense with the spring 26, instead using the inherent elasticity of the material used for the panels for the swiveling and interlocking.

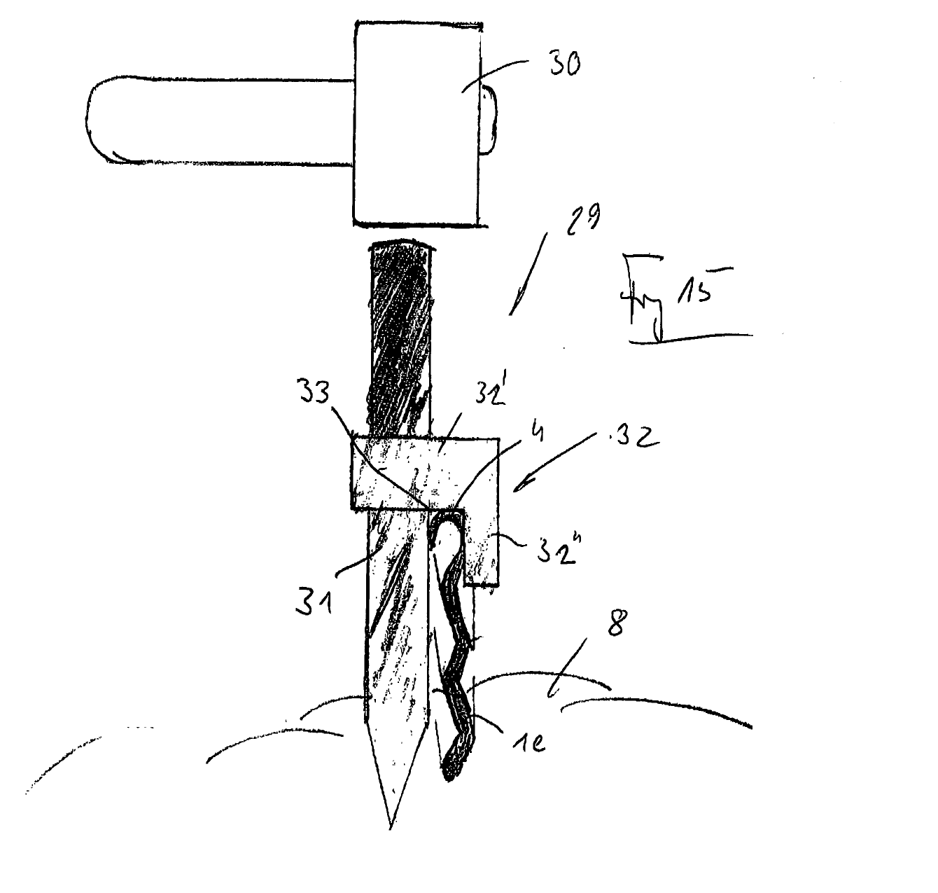

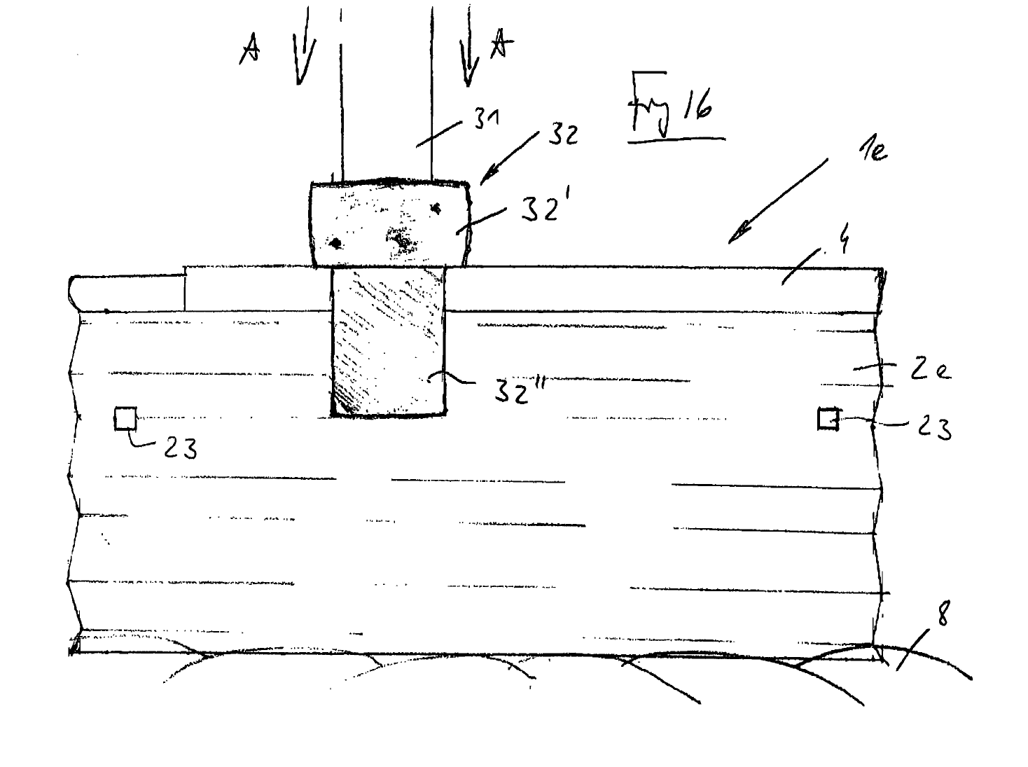

FIGS. 13 and 14 show as a further possible embodiment a dividing element 1f, which differs from the dividing element 1e essentially by the fact that instead of the upper bent edge 4, the panel 2f has a number of brackets 27, which protrude at right angles on a common side of the panel 2f and at a distance from each other. The brackets 27 are designed in such a way that the material of the panel 2f is provided with notches corresponding to the distances 28 between the brackets 27 and the brackets 27 are bent at a right angle. The dividing element 1f is suitable especially for round landscaping dividers, i.e. for curves in the lawn, so that the brackets protrude across the inner side of the curve and the brackets 27 overlap at least on their free ends, as indicated in FIG. 14 for two brackets 27. This results in a particularly stable upper border for the round landscaping divider.

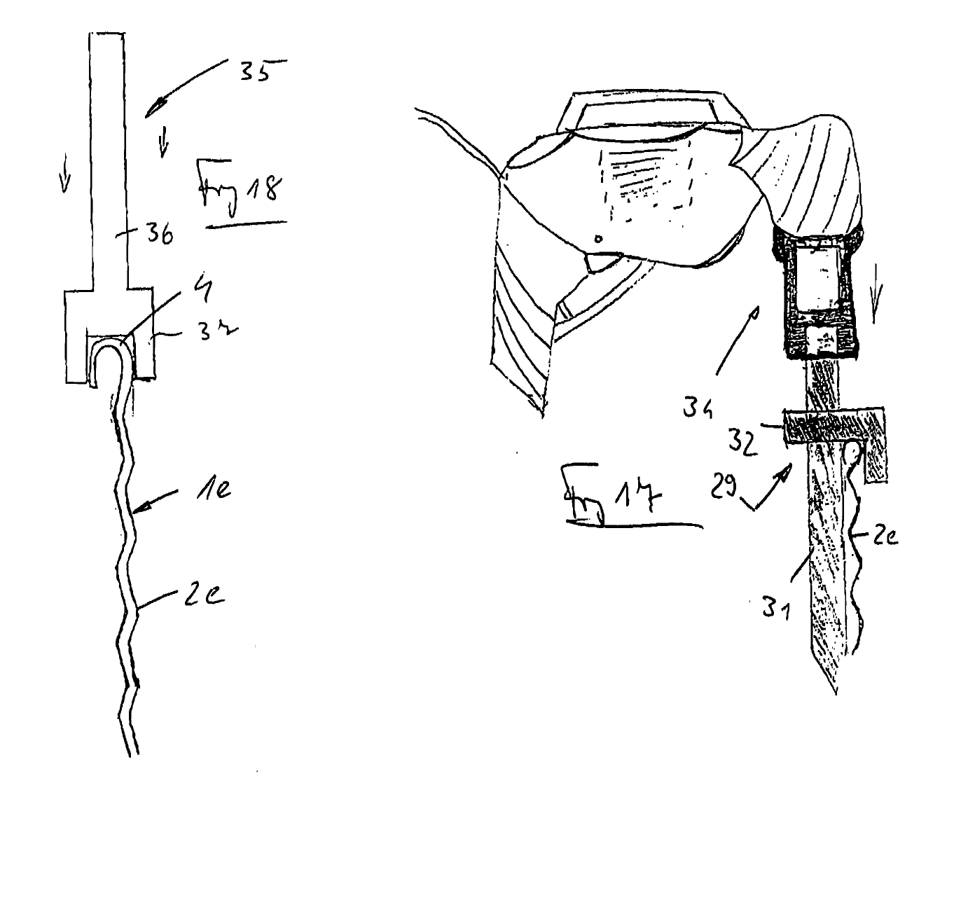

In order to insert the respective dividing element into the ground, for example the dividing element 1a, there is an insertion element 29 as shown in FIGS. 15 and 16, which is suitable for manually driving the dividing element into the ground using a hammer 30 and which includes a guide rod 31 that is pointed on the insertion end and serves as a guide while hammering, and of a receptacle element 32 fastened to this rod so that it cannot be moved axially. The receptacle element 32 forms two legs 32′ and 32″, of which the leg 32′ is connected with the guide rod 31 and protrudes from this guide rod radially and of which the leg 32″ is located at a distance from the rod 31 and parallel to it, in such a way that the leg 32″ extends away from the leg 32′ in the direction of the pointed end of the rod 31. In this way, a receptacle 33 for the upper edge 4 of the respective dividing element 1e or another dividing element to be inserted in the ground is formed between the guide rod 31 and the leg 32′. Insertion takes place by hammering the top end of the guide rod 31, whereby the guide rod 31 is driven deeper into the underlying surface or ground 8 together with the dividing element 1e, providing for exact positioning of the dividing element 1e during insertion and preventing the dividing element from being displaced laterally.

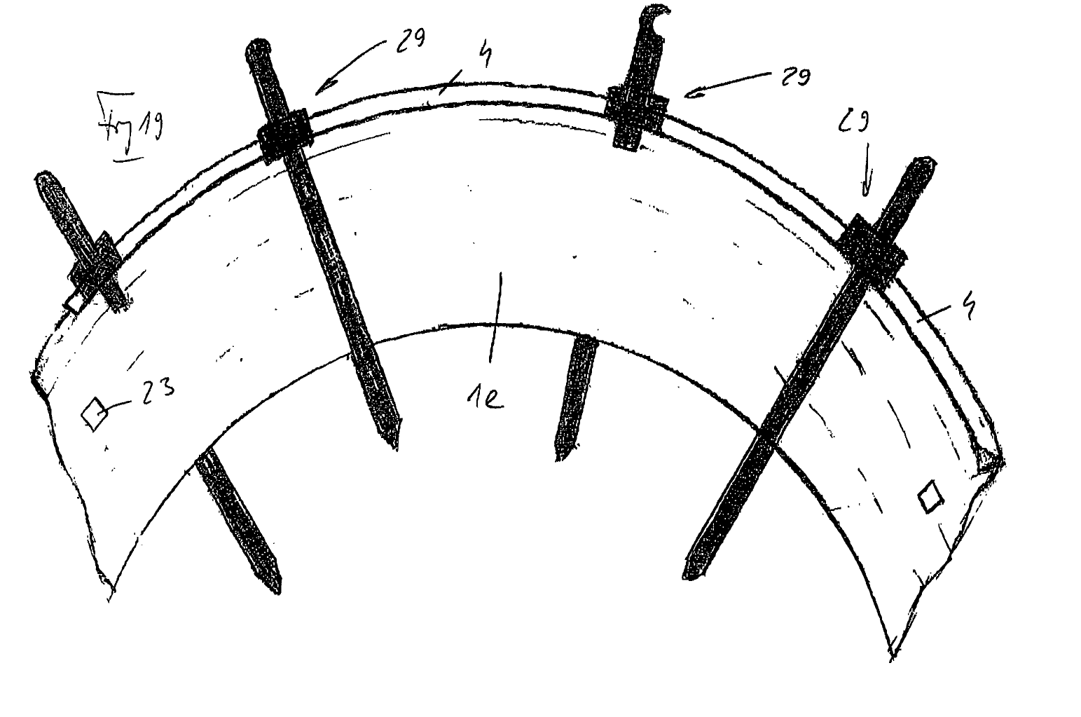

FIG. 17 again shows the insertion element 29, together with the dividing element 1e to be inserted in the ground, however for use not with a hammer 30, but instead with a mechanical insertion tool 34.

Of course, other insertion aids are conceivable. FIG. 18 shows an insertion aid 35, which consists essentially of a strip-like panel 36 extending perpendicular to the drawing plane of this drawing, which (panel) is provided with receptacle 37 on one longitudinal side for a positive fit with the upper edge of the dividing element to be inserted, for example the upper edge 4 of the dividing element 1e. The insertion aid 35 is especially suitable for inserting dividing elements of a landscaping divider extending in a straight line.

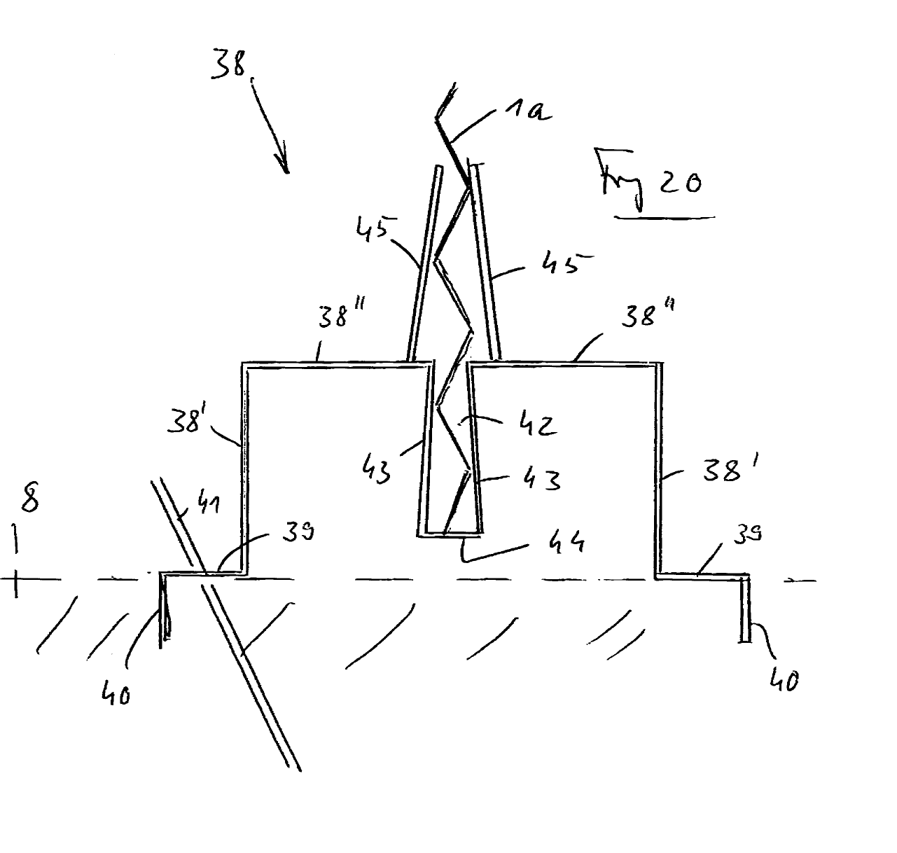

FIG. 19 shows the use of several insertion aids 29 in a curved dividing element 1e. Some of the guide rods 31 of the insertion aids 29 are located on the inner side and some on the outer side of the curve or bend.

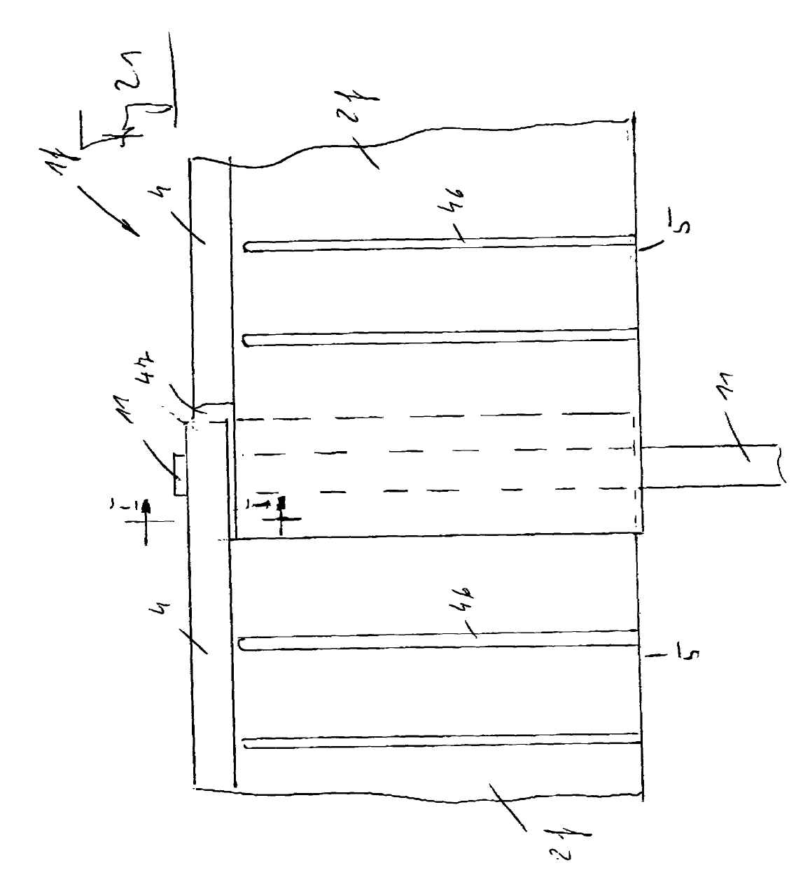

FIG. 20 shows a simplified longitudinal view of a support or holder 38, which is made of a flat material, for example of corrosion-resistant sheet steel by bending and stamping and which serves to hold up a dividing element 1a where the element cannot be driven into the ground, but instead forms a divider together with this dividing element or a number of consecutive dividing elements for which the underlying surface is then filled up to the edge of the dividing elements. The holder 38 then remains in the underlying surface.

In detail, the material forming the holder 38 is bent a number of times, initially in such a way that the holder 38 basically forms a U-shaped cross-section with the two outer legs 38′ and the yoke section 38″ connecting these legs. The ends of the legs 38′ furthest from the yoke section 38″ are provided with a bend 39 forming a support surface for the holder 38, which (bend) protrudes outward laterally beyond the legs 38′ and changes into a further bend 40. While the bend 39 is in a plane that is perpendicular or crosswise to the plane of the leg 38, the bends 40 are in planes that are parallel or nearly parallel to the leg 38′. When the holder 38 is in use, the legs 40 are pressed into the underlying surface, thus securing the holder 38 in the underlying surface. Of course, other securing elements can be used, such as anchors 41 that are driven into the ground.

In the middle of the yoke section 38″ the flat material is bent in such a way that it forms an open channel 42 toward the top of the holder 38, which is limited by two bends 43 on the side and by one bottom 44 below. In the channel 42, the respective dividing element, for example the dividing element 1a, can be inserted with its lower edge so that it is held in this channel 42 and secured against falling over. As depicted, the bends 43 are such that the channel 42 decreases in width toward the upper open side, so that the channels 42 there are supported against the dividing element due to the inherent elasticity of the flat material.

For additional lateral support of the dividing elements, leaf spring support elements 45 are provided, which bear against the dividing element 1a on both sides, in particular above the channel 42. The leaf spring support elements 45 are likewise made of the flat material of the holder 38.

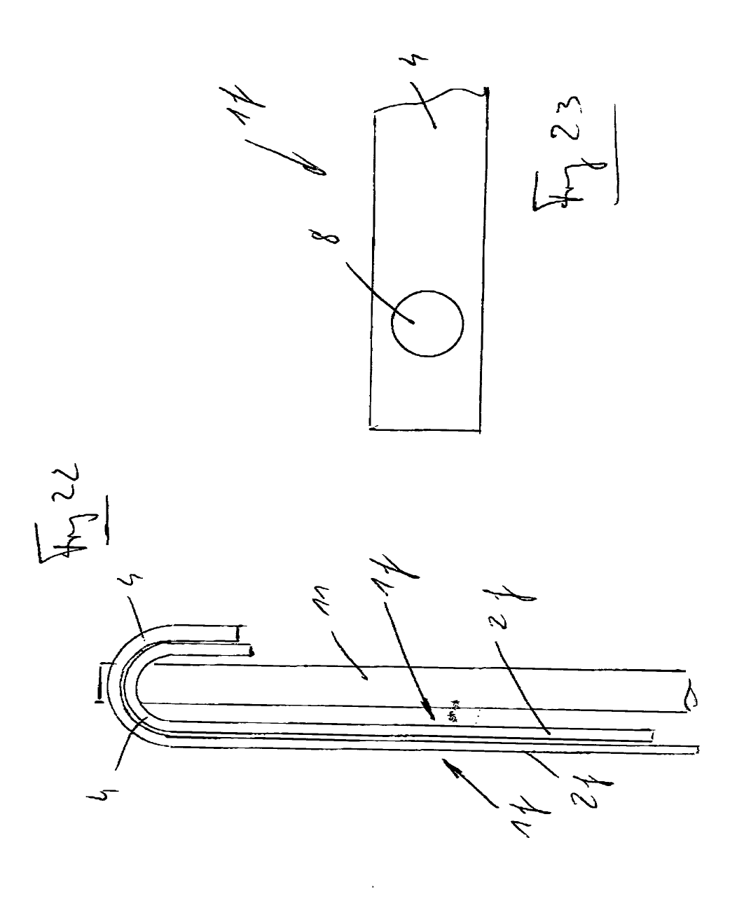

FIGS. 21-23 show as a further embodiment two consecutive dividing elements 1f, which likewise consist of a panel 2f made of a corrosion-resistant material, for example of corrosion-resistant steel and have a bent edge 4 on the top.

In the direction of insertion, i.e. in the axis that is perpendicular to the upper edge 4, the panels 2f are provided with a number of grooves 46 reinforcing the panel, which are manufactured as groove-like protuberances in the respective panel 2f and extend from the upper edge 4 to the lower longitudinal edge 5.

In order to connect several dividing elements 1f so that they overlap, the bent edge 4 is widened somewhat on one end of each panel 2f along an area 47, so that the inner cross-section there of the U-shaped bent edge 4 corresponds to the outer cross-section, which the edge 4 possesses outside of the area 47 and in particular also on the other end of the panel 2f. This enables consecutive dividing elements 1e to be inserted so that their bent edges 4 overlap. In the area 47 and also on the other end, each plate 2e is provided with an opening 48 on the bent edge 4 corresponding to the opening 6. With consecutive dividing elements 1f, the openings 48 of the consecutive dividing elements 1f are congruous, so that a rod 11 can be inserted in the openings 48 for additional anchoring and connecting of the consecutive dividing elements 1e in the ground.

While the present invention was described above based on exemplary embodiments, it will be understood that various changes and modifications are possible. The above embodiments have in common that the dividing elements 1a, 1b, 1c and 1d can be inserted into the ground 8 without digging, especially in existing landscaping areas (gardens, parks, etc.). To make insertion into the ground 8 easier, the dividing elements 1a-1f, for example, have a form that is similar to a knife blade on the lower edge 5.

It was assumed in the above discussion that the openings 6 or the pipe sections 14 serve to receive and hold rods for fences or dividers. Especially on steep hills, however, these rods 11 can be used as an additional anchor for holding onto or to prevent slipping.

It was assumed in the above discussion that the respective insertion aid 29 is removed after insertion of the dividing element. If suitably designed, the insertion aids can, of course, also remain in the ground as an additional support element for the dividing element.

List of reference numbers

| 1a, 1b, 1c, 1d, 1e, 1f | dividing element |
|---|---|
| 2a, 2b, 2c, 2d, 2e, 2f | panel |
| 3 | profile or corrugation |
| 4 | bent edge |
| 4′, 4″ | leg |
| 4′″ | yoke section |
| 5 | lower longitudinal edge |
| 6, 7 | opening |
| 8 | ground or underlying surface |
| 9 | lawn |
| 10 | connecting element |
| 11 | rod |
| 12 | anchor |
| 13 | bent edge |
| 13′, 13″ | leg |
| 13′″ | yoke section |
| 14 | pipe section |
| 15 | divider |
| 16 | connecting element |
| 17 | recess |
| 18 | connecting element |
| 18′ | leg |
| 18″ | yoke section |
| 19 | notch |
| 20 | screw |
| 21 | screw head |
| 22 | shank section |
| 23 | opening |
| 24 | threaded section |
| 25 | nut |
| 26 | pressure spring |
| 27 | bracket |
| 28 | space |
| 29 | insertion element |
| 30 | hammer |
| 31 | guide rod |
| 32 | receptacle element |
| 32′, 32″ | leg |
| 33 | receptacle |
| 34 | insertion tool |
| 35 | insertion element |
| 36 | panel |
| 37 | receptacle |
| 38 | support or holder |
| 38′ | leg |
| 38″ | yoke section |
| 39, 40 | bend |
| 41 | anchor |
| 42 | receptacle or channel |
| 43 | bend |
| 44 | ground |
| 45 | support element |
| 46 | groove |
| 47 | section |
| 48 | opening |

What is claimed is:

1. A dividing element for a landscape divider, comprising a panel, that has an upper edge forming a U-shaped cross-section or profile, wherein the panel of the dividing element, which can be driven into the ground without digging, is made of corrosion-resistant sheet steel.

2. The dividing element of claim 1, wherein the panel is corrugated to form a profile parallel to the U-shaped edge produced on a top of the panel by bending the panel.

3. The dividing element of claim 1, wherein the panel is corrugated or fluted crosswise to the U-shaped edge produced on the top of the panel by bending the panel.

4. The dividing element of claim 1, wherein the upper edge has openings provided for the insertion of rods or anchors laid in the underlying surface.

5. A dividing element for a landscape divider, comprising a profiled panel made of a flat material, wherein the panel is made of corrosion-resistant steel, and has at least one opening for insertion of a rod-shaped ground anchor, longitudinal side of which is perpendicular to plane of the panel.

6. A dividing element for a landscape divider, comprising a profiled panel made of a flat material, provided with a U-shaped bent edge on two cross sides extending perpendicular to a panel top and a panel bottom, wherein the panel is made of corrosion-resistant sheet steel, and for the purpose of connecting two consecutive dividing elements, fork-like connecting pieces are provided, each of which interlocks with one leg in a bent edge of consecutive dividing elements.

7. The dividing element of claim 5, wherein the panel is a U-shaped cross-section on its upper edge.

8. The dividing element of claim 1, wherein the upper bent edge on one side of the dividing element is notched and widened along a predetermined length or openings are provided in the dividing element for connection of consecutive dividing elements.

9. The dividing element of claim 1, wherein in the dividing element is curved in a shape of a ring.

10. A landscape divider manufactured using several consecutive dividing elements as claimed in claim 1.

11. The dividing element of claim 10, wherein the dividing elements interlocking with their profile are connected with each other by means of a spring-mounted swivel connection, which enables swiveling on an axis upon simultaneous axial outward movement of the dividing elements against a spring effect.

12. The dividing element of claim 1, further comprising at least one holder or support for at least one dividing element.

13. The dividing element of claim 1, further comprising an insertion element for inserting the dividing element, whereby the insertion element has a guide rod.

14. The dividing element of claim 1, wherein a plurality of dividing elements overlap an area of their upper bent edges.

15. The dividing element of claim 1, wherein the dividing element is made of chromium steel.

16. The dividing element of claim 6, wherein the panel is a U-shaped cross-section on its upper edge.
